(19) United States
(12) Patent Application Publication
(10) Pub. No.: US 2018/0097809 A1
(43) Pub. Date: Apr. 5, 2018

(54) SECURING ACCESS TO CLOUD COMPONENTS

(71) Applicant: Intel Corporation, Santa Clara, CA (US)

(72) Inventors: Somnath Chakrabarti, Portland, OR (US); Mona Vij, Hillsboro, OR (US); Carlos V. Rozas, Portland, OR (US); Brandon Baker, Portland, OR (US); Vincent R. Scarlata, Beaverton, OR (US); Malini K. Bhandaru, San Jose, CA (US); Ning Sun, San Jose, CA (US); Jun Nakajima, San Ramon, CA (US); Francis X. McKeen, Portland, OR (US); Simon P. Johnson, Beaverton, OR (US)

(73) Assignee: Intel Corporation, Santa Clara, CA (US)

(21) Appl. No.: 15/283,208

(22) Filed: Sep. 30, 2016

(51) Int. Cl. H04L 29/06

(52) U.S. Cl. CPC H04L 63/10; H04L 63/126; H04L 63/08

(57) ABSTRACT

Particular embodiments described herein provide for receiving a request from a first cloud component in a cloud network, wherein the request is to access a key and the key allows the first cloud component to access located trusted execution environment of a second cloud component in the cloud network and allow the request on the condition that the first cloud component is authenticated. A more specific example includes determining a type for the first cloud component, and comparing the determined type of the first cloud component with a component type associated with the key. The example may also include blocking the request if the determined type of the first cloud component does not match the component type associated with the key.

### TECHNICAL FIELD

This disclosure relates in general to the field of information security, and more particularly, to securing access to cloud components.

### BACKGROUND

The field of network security has become increasingly important in today's society. In particular, a cloud network can provide a medium for exchanging data between different devices connected to different computer networks. While the use of a network has transformed business and personal communications, it has also been used as a vehicle for malicious operators to gain unauthorized access to computers and computer networks and for intentional and inadvertent disclosure of sensitive information.

In a cloud computing system, confidential information is stored, transmitted, and used by many different information processing systems. Techniques have been developed to provide for the secure handling and storing of confidential information. These techniques include various approaches to creating and maintaining a secured, protected, or isolated partition or environment within an information processing system. Securing access to cloud components, however, continues to present a significant challenge to network administrators.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for securing access to cloud components in accordance with an embodiment of the present disclosure;

FIG. 2 is a simplified flowchart illustrating potential operations that may be associated with the communication system in accordance with an embodiment;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EMBODIMENTS

The following detailed description sets forth example embodiments of apparatuses, methods, and systems relating to a communication system for securing access to cloud components in a network environment. Features such as structure(s), function(s), and/or characteristic(s), for example, may be at times described with reference to one embodiment as a matter of convenience; various embodiments may be implemented with any suitable one or more of the described features.

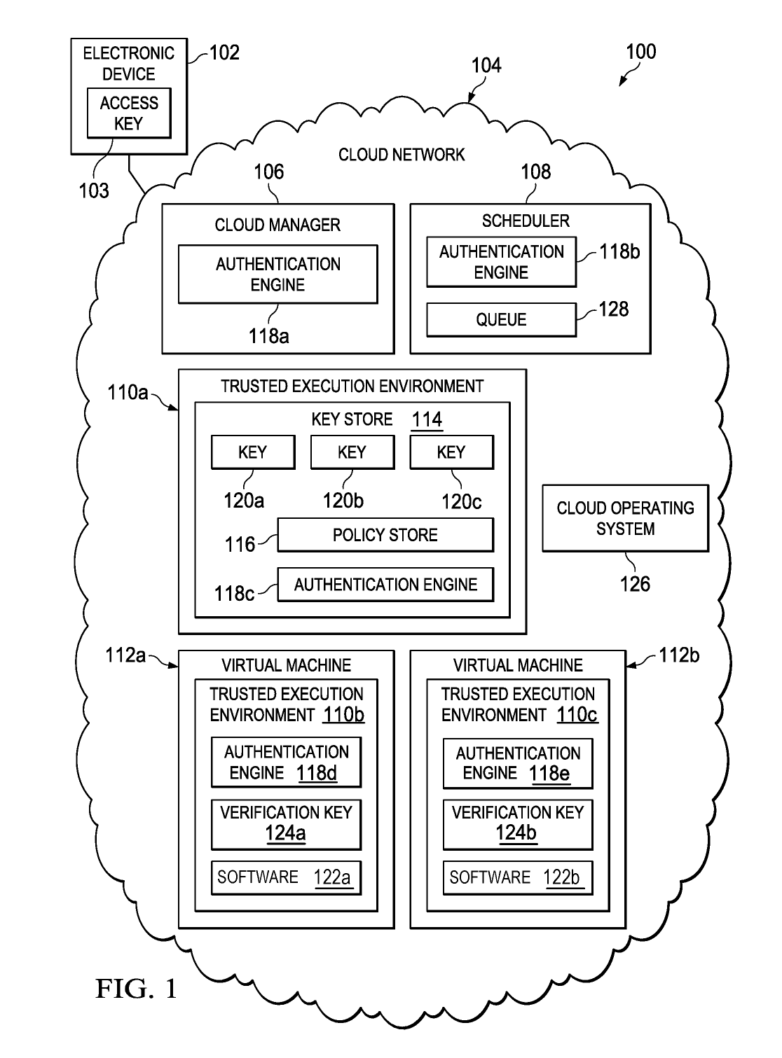

FIG. 1 is a simplified block diagram of a communication system 100 for securing access to cloud components in accordance with an embodiment of the present disclosure. Communication system 100 can include an electronic device 102 and a cloud network 104. Electronic device 102 can include an access key 103, which can be provided to cloud network 104 to enable cloud components to access encrypted data or other sensitive data or processes, for example.

Cloud network 104 can include a cloud manager 106, a scheduler 108, a trusted execution environment (TEE) 110a, and one or more virtual machines 112a and 112b. The various cloud services within cloud network 104 may be collectively referred to herein as a cloud operating system (OS) 126. For example, cloud OS 126 could comprise cloud manager 106, scheduler 108, TEE 110a, and virtual machines 112a and 112b. Cloud manager 106 can include an authentication engine 118a. Scheduler 108 can include an authentication engine 118b. TEE 110a can include a key store 114. Key store 114 can include one or more keys (e.g., keys 120a-120c), a policy store 116, and an authentication engine 118c. Virtual machine 112a can include a trusted execution environment (TEE) 110b. TEE 110b can include an authentication engine 118d, software 122a, and a verification key 124a. Virtual machine 112b can include a trusted execution environment (TEE) 110c. TEE 110c can include an authentication engine 118e, software 122b, and a verification key 124b. In an example, cloud network 104 is a portion of a cloud computing system. In at least some scenarios, cloud network 104 may be managed by a cloud service provider (CSP).

In an example, virtual machines 112a and 112b may each be a virtual machine running on a network element in cloud network 104. TEEs 110a-110c may each be some type of a secure domain such as an enclave, a protected container, etc. Authentication engines 118a--118e may each be configured to authenticate requests to access a cloud component (e.g., authentication engine 118a can authenticate requests to access cloud manager 106, authentication engine 118b can authenticate requests to access scheduler 108, authentication engine 118c can authenticate requests to access key store 114 of TEE 110a, authentication engine 118d can authenticate requests to access TEE 110b of virtual machine 112a, authentication engine 118e can authenticate requests to access TEE 110c of virtual machine 112b, etc.).

Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

In an example, communication system 100 can be configured to enable secure access to cloud components. In an illustrative example, a trusted execution environment can be configured to receive a request from a cloud component, determine if the cloud component is authenticated, and allow the request on the condition that the cloud component is authenticated. In an example, the request is to access a key from a key store in the trusted execution environment, where the key allows the cloud component to access data, code, or services of another cloud component. In at least one embodiment, the desired data, code, or services may be provided in a trusted execution environment of the other cloud component. In another example, the electronic device or key store can receive a verification key from the cloud component, where the verification key at least partially determines if the cloud component is authenticated. In a specific example, communication system 100 can identify legitimate cloud components from non-legitimate cloud components using verification keys (e.g., verification key 124a to verify virtual machine 112a and verification key 124b to verify virtual machine 112b).

For purposes of illustrating certain example techniques of communication system 100, it is important to understand the communications that may be traversing the network environment. The following foundational information may be viewed as a basis from which the present disclosure may be properly explained.

End users have more communications choices than ever before. A number of prominent technological trends are currently afoot (e.g., more computing devices, more connected devices, etc.). One current trend is using a network, especially using a cloud based network computing system. Cloud networking is a new networking paradigm for building and managing secure private networks over the public Internet by utilizing global cloud computing infrastructure. In cloud networking, traditional network functions and services including connectivity, security, management and control, are pushed to the cloud and delivered as a service. Cloud-based networks only require an Internet connection. They can work over any physical infrastructure, wired or wireless, public or private. A cloud operating system (OS) can be configured to provide logging and schedule tasks with different machines running on the cloud. The machines may use different software and the OS can function similarly to middleware. Additionally, one or more of the machines may be virtualized. A virtualized machine may run separate applications in separate virtual machines.

One of the main functions of the cloud OS is to schedule tasks or jobs based on priority and criteria of the task. The cloud OS can keep statistical data regarding each virtual machine running on the cloud and when a task is sent to the cloud, the cloud OS can review the statistical data and send the task to a queue (e.g., queue 128). A scheduler can pick up queue entries, analyze the parameters and assign the task to a specific machine. However, once a task is submitted to the queue and picked up by the scheduler, there is not trusted way to ensure that the parameters that were submitted are the actual parameters that are being scheduled. Also, the scheduler itself could be attacked and could select a wrong cloud component for a task. What is needed is a system that can be configured to secure cloud components.

A communication system that can secure access to cloud components, as outlined in FIG. 1, can resolve these issues (and others). In an example, different cloud elements can be hardened to help secure the cloud network so the correct task is assigned to the correct cloud element. When a cloud component is assigned or selects a task, the cloud component can have some level of confidence that the task was correctly assigned. In a specific example, a key store can be used to store keys. The keys can be used to help ensure the correct cloud component is accessing the correct data and cloud components. In another specific example, a user can provide specific keys for a specific network element (e.g., virtual machine) and the specific key can be stored in the key store. The key store can store keys required to access each cloud element as well as user keys.

Each of the cloud components can include a verification key to authenticate they are a verified cloud component and they are who they say they are. Because the cloud components are verified, the data can be encrypted using known encryption to protect the flows. Each cloud component can request access to a key to decrypt, access, or authenticate cloud OS messages. In an example, any authorized component can ask for access to any part of the cloud network. In another example, the system can check to see if a cloud component requests the proper key. For example, a cloud component that only sends data should only have access to keys related to sending data. In other words, only senders of data are allowed sender keys. When a cloud component is created or provisioned, the verification key can be assigned to ensure the device has the proper verification key and is who the device says it is.

Several advantages are provided by embodiments of communication system 100. Embodiments described herein enable a two-factor authentication to ensure that a requester (e.g., of data, code, services, etc.) is running the software that is expected. For example, if a requester asserts that it is a key store (e.g., key store 114) running in a trusted execution environment of cloud network 104, it can publish its software and allow other entities or cloud components download the software (if desired), inspect the software, and possibly generate a hash of the software. An entity that interacts with the TEE of the key store can also receive an assertion (e.g., from a cloud service provider) for the key store. Thus, the key store can be authenticated based on two factors. Another advantage involves the significant amount of software that may be running in a cloud network. When software runs in a TEE (e.g., key store 114, software 122a, software 122b), the software is secured and isolated from the rest of the software in the cloud network. Thus, the amount of other software that the secured software needs to trust may be reduced.

Turning to the infrastructure of FIG. 1, communication system 100 in accordance with an example embodiment is shown. Generally, communication system 100 can be implemented in any type or topology of networks. Cloud network 104 represent a series of points or nodes of interconnected communication paths for receiving and transmitting packets of information that propagate through communication system 100. Cloud network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals (analog, digital or any combination of the two), data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol in at least one embodiment. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, cloud manager 106, scheduler 108, TEE 110a, and virtual machines 112a and 112b are cloud network elements, which are meant to encompass network appliances, servers, routers, switches, gateways, bridges, load balancers, processors, modules, or any other suitable virtual or physical device, component, element, or object operable to exchange information in a network environment. Network elements may include physical devices and/or virtualized elements and may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 102, cloud manager 106, scheduler 108, TEE 110a, and virtual machines 112a and 112b can include memory elements for storing information to be used in the operations outlined herein. Each of electronic device 102, cloud manager 106, scheduler 108, TEE 110a, virtual machine 112a and 112b may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 102, cloud manager 106, scheduler 108, TEE 110a, and virtual machines 112a and 112b may include software modules (e.g., authentication engines 118a-118e) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network element to achieve the intended functionality. Furthermore, the modules can be implemented as software, hardware, firmware, or any suitable combination thereof. These elements may also include software (or reciprocating software) that can coordinate with other network elements in order to achieve the secure access operations, as outlined herein.

Additionally, each of electronic device 102, cloud manager 106, scheduler 108, TEE 110a, and virtual machines 112a and 112b may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Cloud manager 106, scheduler 108, TEE 110a, and virtual machines 112a and 112b can be network elements and include, for example, physical or virtual servers or other similar elements that may be used in a cloud services architecture. Cloud services may generally be defined as the use of computing resources that are delivered as a service over a network, such as the Internet. The services may be distributed and separated to provide required support for electronic devices, such as electronic device 102. Typically, compute, storage, and network resources are offered in a cloud infrastructure, effectively shifting the workload from a local network to the cloud network. At least some network elements in a cloud services architecture can be physical or virtual servers and can be associated with clients, customers, endpoints, or end users wishing to initiate a communication in communication system 100 via some network. The term ‘server’ is inclusive of devices used to serve the requests of clients and/or perform some computational task on behalf of clients within communication systems 100.

Generally, a trusted execution environment, such as TEEs 110a, 110b, and 110c, offer hardware-based security to ensure that sensitive data (including code) is stored, processed and protected in an isolated, trusted environment. For example, this isolation can prevent external entities from gaining access to sensitive data uploaded by a user, to keys used to provide access to cloud components, and/or to code used to execute certain processes. A TEE can allocate resources and prevent non-secure applications from accessing certain memory. Thus, the TEE can control the use of underlying hardware resources. One non-limiting example of a trusted execution environment is an enclave that provides isolated memory regions of code and data, where the enclave is hardened by CPU-based security mechanisms (e.g., privileged execution modes associated with processors, access protection mechanisms associated with memory, firmware to prevent unauthorized access, etc.). Examples of TEEs that may be implemented by embodiments described herein include, but are not limited to, Software Guard Extension (SGX) developed by Intel Corporation and Trusted Execution Technology (TXT) developed by Intel Corporation. It will be apparent, however, that embodiments are not limited by a particular type of TEE and may implement numerous other types of trusted execution environments to achieve the desired functionalities outlined herein.

In at least one embodiment, TEE 110a may be implemented in a server in cloud network 104. TEE 110a includes code to manage access to keys 120a-120c. Keys 120a-120c can be provisioned in key store 114 to enable access to cloud components and data in the cloud network. For example, key store 114 could include keys that enable access to cloud manager 106, scheduler 108, virtual machine 112a, and virtual machine 112b. As used herein, a request for ‘access’ (or ‘access request’) sent to a cloud component, is intended to include any type of operation (e.g., read, write, modify, replace, delete, execute, etc.) on data or code associated with the cloud component, or any type of command directed to the cloud component to take an action or perform a task. When obtained by an entity from key store 114, a key that corresponds to a cloud component can enable the requesting entity to access the cloud component by authenticating the requesting entity to the cloud component. In at least one scenario, the requesting entity can be another cloud component of cloud network 104.

Keys in a key store of a TEE may be provisioned using any suitable techniques. In some scenarios, keys may be uploaded by one or more users of the cloud network. For example, a user associated with electronic device 102 may upload a set of keys to enable access to encrypted data by certain cloud components in the cloud network, or to enable access to a cloud component to run a process using sensitive data. In other scenarios, one or more keys in key store 114 may be automatically generated by key store 114 or another network element that is configured to provide keys to key store 114.

In yet other scenarios, IT administrators with local or remote access to cloud network 104 may provision one or more keys in key store 114. For example, an IT administrator of a cloud service provider (CSP) of cloud network 104 may provision keys in key store 114 to enable certain cloud components to send commands to other cloud components. For example, cloud manager 106 may send a command to virtual machine 112a to dedicate resources for certain processes (e.g., creating a virtual machine). Virtual machine 112a may not respond to the command unless cloud manager 106 presents an appropriate key that authenticates the cloud manager as authorized to make the command. In at least one embodiment, keys that are provisioned by a CSP (e.g., an IT administrator or automatically) may be stored in a separate key store from the key store that contains keys provisioned by users (e.g., electronic device 102) of cloud network 104. These separate key stores may be contained in the same or separate trusted execution environments.

Any number of actions may be performed to provision and maintain keys in key store 114. Actions can include, but are not limited to uploading a key, deleting a key, directing the key store to update policies associated with the key, requesting an automatically generated key from the key store, etc. Depending on the implementation and the type of key, a user, an IT administrator, or a network element may perform an action to provision and maintain keys or may request the key store to perform an action to provision and maintain keys.

In order to obtain keys 120a-120c, an entity that desires access to a cloud component can request the desired key from key store 114 in TEE 110a. A requesting entity can include any software, device, element or object capable of communicating with TEE 110a. For example, requesting entities could include a cloud component (e.g., cloud manager 106, scheduler 108, virtual machine 112a, virtual machine 112b, etc.) and electronic device 102. Several different techniques may be implemented to enable authentication to be performed in TEE 110a for an entity that requests access to the keys provisioned in key store 114. In at least one embodiment, authentication engine 118c can perform the authentication. In a first technique, policies associated with one or more keys 120a-120c can be uploaded to policy store 116 or otherwise provided to TEE 110a. A policy could be based on a policy key. For example, if a requesting entity has the policy key, then the requesting entity can be authenticated and the requested key may be provided to the requesting entity. In another example, public key cryptography could be used to verify a certificate that identifies the cloud component. If the requesting entity requests a key and provides an appropriate certificate with the policy key (e.g., a public key) to TEE 110a, then the requesting entity can be authenticated and the requested key may be provided to the requesting entity.

In another example technique, an entity, such as software running on a cloud component, that requests a key from key store 114 can be evaluated to attempt to authenticate the software based on certain criteria of a policy (e.g., in policy store 116). The criteria required to authenticate the software that requests a key could include where the software is running and/or whether the software is included in an approved software list. These evaluations may be made, for example, based on a hash of the software or on a hash of one or more portions of the software. For example, if a determination is made that the software is running in another TEE (e.g., software 122a, software 122b) and that the software is included in the approved software list, then the software may be provided with the requested key.

In yet another example technique, other criteria may be used to attempt to authenticate software running on a cloud component that requests a key from key store 114. The other criteria can include a determination of whether the software was signed using an appropriate or valid signing key. If an attestation is provided that shows the software was signed by an appropriate signing key, then the software can be provided with the requested key to access a desired cloud component. An attestation is a mechanism that allows a TEE in a cloud component to authenticate itself as a trusted execution environment running software (e.g., software 122a, software 122b) signed by an appropriate signing key, for example. The attestation can be made to the key store in TEE 110a in one example, to show the software that is requesting a key from the key store is running in a TEE and is signed by an appropriate or valid signing key.

In one example scenario, a request from a cloud component for a key that enables access to sensitive data can include an attestation that shows the request is from software (e.g., software 122a, software 122b) running in a trusted execution environment of the cloud component. Key store 114 can evaluate one or more policies to determine whether the cloud component is authorized to obtain the requested key in order to access the sensitive data. In one example, the requesting cloud component could be a virtual machine of a user and the sensitive data may be owned by the user. Prior to the request for the key, the user can upload policies and/or other information to the key store indicating that the cloud component is authorized to access the key.

In at least some embodiments, one or more keys in key store 114 can be associated with respective policies that specify particular types of cloud components that can be authenticated to obtain the keys when requested. For example, numerous services (e.g., cloud manager 106, scheduler 108, etc.) may be associated with cloud operating system 126. A cloud component having a certain component type may be authenticated to receive key 120a, but not keys 120b and 120c. For example, a scheduler may need to access different data and cloud components than a cloud billing service. Therefore, a key for accessing data needed by a scheduler can be associated with a component type of the scheduler, but a key for accessing data needed by a cloud billing service is associated with a different component type that corresponds to the billing service.

In some implementations, key store 114 is TEE-aware and may provision keys that can be used to access other key stores that are not TEE-aware. For example, one or more keys 120a-120c may be used to access a key store of a video streaming service available to customers across a large geographic area. In this example, cloud component may request a key from key store 114 for the streaming service. If the cloud component is authenticated, TEE 110a provides the appropriate key to the cloud component. The cloud component may then use the obtained key to request another key from a key store of the video streaming service. If the cloud component is authenticated based on the key it provides to the key store of the streaming service, then the key store of the streaming service can provide a new key to the cloud component for accessing the streaming service to watch a desired video, for example. This may be particularly useful if the video streaming service is a legacy system that does not recognize trusted execution environments. The keys provided in key store 114 of TEE 110a can be configured as keys that are recognizable to the legacy system. Thus, the introduction of key store 114 enables more robust security.

Authentication engines can be provisioned in other cloud components of cloud network 104, such as cloud manager 106, scheduler 108, and virtual machines 112a and 112b. Authentication engines 118a, 118b, 118d, and 118e may perform authentication of an entity (e.g., a cloud component in cloud network 104) that requests access to their respective cloud components. An access request may include, but is not limited to, requesting access to code, data or services of a cloud component. In some scenarios, an access request may include a command to the cloud component to perform some operation (e.g., create a virtual machine, etc.) or task. The requesting entity may be authenticated and granted the particular access requested based on the requesting entity providing an appropriate key obtained from key store 114. If an appropriate key for the access requested is not provided by the requesting entity to the cloud component, then the access request may be denied.

In some implementations, if all cloud components run in a trusted execution environment, then attestation mechanisms of the TEEs may be leveraged by the cloud components to provide access control. For example, if cloud manager 106 and scheduler 108 both run in respective trusted execution environments, then cloud manager 106 and scheduler 108 can exchange attestations with each other, or with other cloud components running in their own trusted execution environments (e.g., virtual machines 112a and 112b). In at least one embodiment, when attestations can be exchanged between cloud components running in secure environments such as a TEE, then access control may be based on these attestations rather than on keys obtained from a key store.

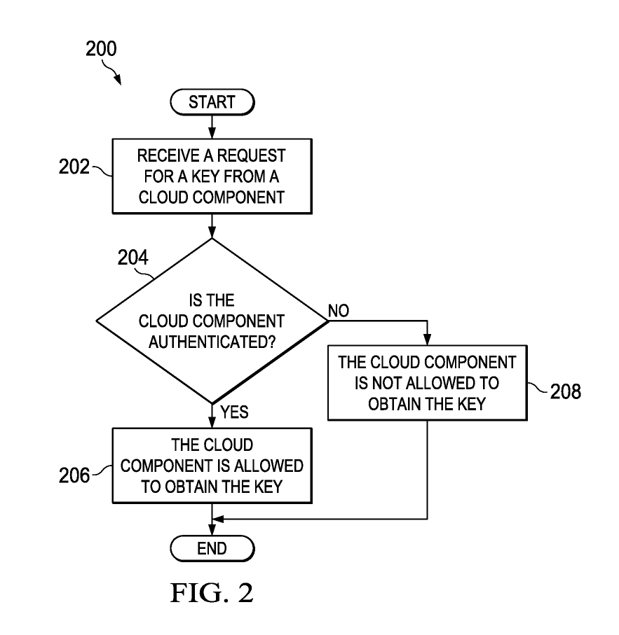

Turning to FIG. 2, FIG. 2 is an example flowchart illustrating possible operations of a flow 200 that may be associated with securing access to cloud components, in accordance with an embodiment. In an embodiment, one or more operations of flow 200 may be performed by TEE 110a, and in particular, by key store 114. TEE 110a may be associated with means, such as one or more processors, for performing the operations.

At 202, a request is received by TEE 110a for a key. The request may be received by key store 114 from a cloud component in cloud network 104, for example. At 204, the key store determines if the cloud component is authenticated. This authentication may depend upon one or more of the particular key being requested, the particular cloud component that is requesting the key, and the type of authentication implemented by the system. In one example, the cloud component can be authenticated based on the cloud component providing a policy key that corresponds to a policy associated with the key. The policy may be stored in TEE 110a in one embodiment. In another example, the cloud component can be authenticated based on a determination that software requesting the key is running in a trusted execution environment of the cloud component and that the software is identified in an approved software list. The approved software list may be stored in TEE 110a in one embodiment. In yet another example, the cloud component can be authenticated based on an attestation indicating that the software requesting the key was signed by an appropriate signing key.

If the cloud component is authenticated as determined at 204, then the cloud component is allowed to obtain the key, as in 206. In at least one embodiment, the key store may encrypt the requested key and send the encrypted key to the authenticated cloud component. If the cloud component is not authenticated as determined at 204, then the cloud component is not allowed to obtain the requested key, as in 208.

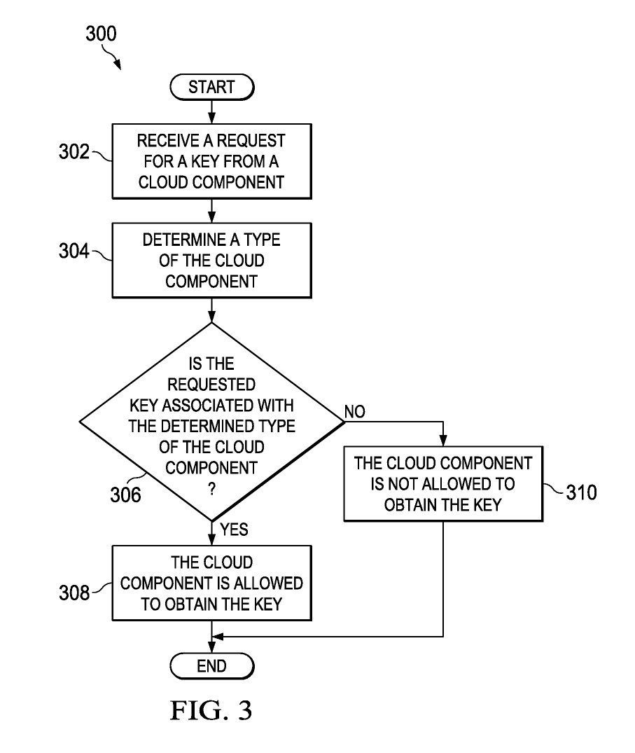

Turning to FIG. 3, FIG. 3 is an example flowchart illustrating possible operations of a flow 300 that may be associated with securing access to cloud components, in accordance with an embodiment. In an embodiment, one or more operations of flow 300 may be performed by TEE 110a, and in particular, by key store 114. TEE 110a may be associated with means, such as one or more processors, for performing the operations.

At 302, a request is received by TEE 110a for a key. The request may be received by key store 114 from a cloud component in cloud network 104. At 304, a type is determined for the cloud component. For example, the type could include, but is not limited to a cloud manager, a scheduler, a billing service, a data processing service, a database manager, etc. At 306, the key store determines if the requested key is associated with the determined type of cloud component. In at least one embodiment, the cloud component can provide an attestation to TEE 110a that indicates the request for the key is associated with software running in a trusted execution environment. The attestation may also indicate the type of the cloud component.

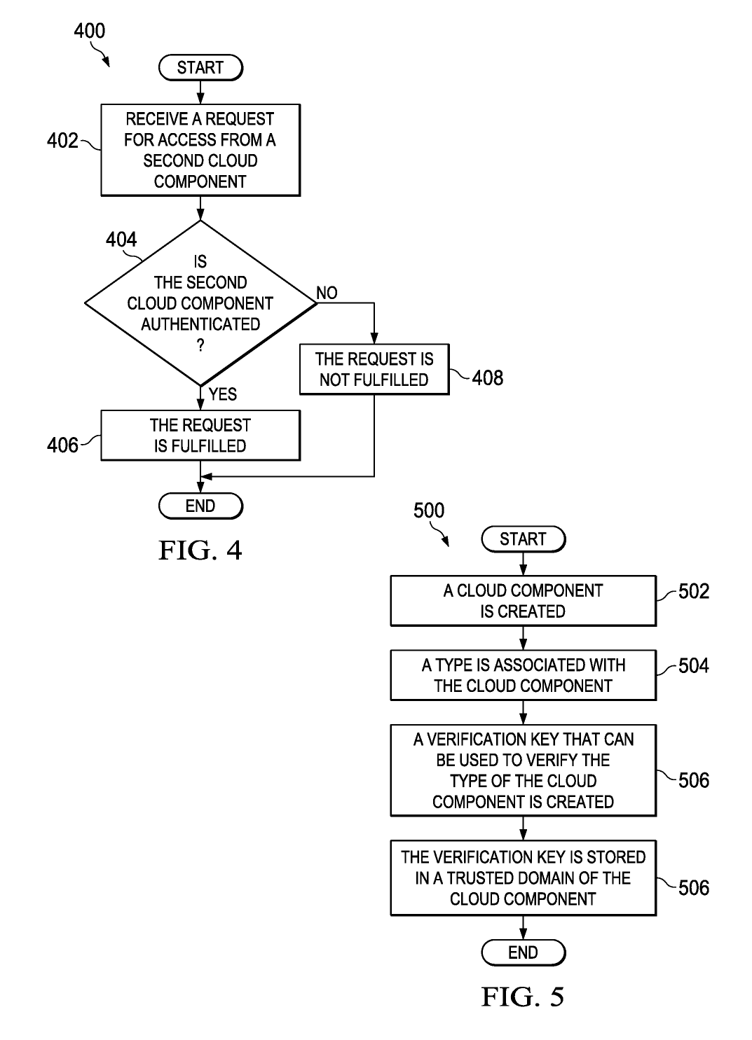

If a determination is made that the requested key is associated with the determined type of cloud component, then the cloud component is allowed to obtain the key, as in 308. In at least one embodiment, the key store may encrypt the requested key and send the encrypted key to the authenticated cloud component. If a determination is made that the requested key is not associated with the determined type of cloud component, then the cloud component is not allowed to obtain the requested key, as in 310. It should be noted that operations of FIG. 3 and FIG. 4 may be combined in any suitable manner to enable various techniques of authentication for obtaining keys in the key store. For example, the type of a cloud component may be evaluated and if the key is not associated with the determined type, then the other types of authentication may be evaluated (e.g., policy key, attestation showing requesting software was signed, attestation showing requesting software is running in a TEE, software list identifying approved software for the key, etc.).

Turning to FIG. 4, FIG. 4 is an example flowchart illustrating possible operations of a flow 400 that may be associated with securing access to cloud components, in accordance with an embodiment. In an embodiment, one or more operations of flow 400 may be performed by a cloud component including, but not limited to, cloud manager 106, scheduler 108, virtual machine 112a, or virtual machine 112b. In particular, authentication engines 118a, 118b, 118d, or 118e may perform one or more operations of flow 400, based on the cloud component that receives a request for access from another cloud component.

At 402, a first cloud component receives a request for access from a second cloud component. A request for access can include, but is not limited to, any operation to be performed on data or in relation to code or services provided by the first cloud component. A request for access can also include a command from the second cloud component to the first cloud component to take an action or perform a task (e.g., allocate resources for and create a virtual machine, etc.).

At 404, the first cloud component determines if the second cloud component is authenticated. The second cloud component can be authenticated if the second cloud component presents an appropriate key for the access request to the first cloud component. For example, if the request from the second cloud component is to access sensitive data stored by the first cloud component, then the second cloud component may have previously obtained a key from a key store (e.g., key store 114) that authorizes access to the sensitive data and may have provided the key to the first cloud component along with the access request. In another embodiment, if the sensitive data is contained in a trusted execution environment of the first cloud component, then the access request may be granted based on the request being sent from software running in a trusted execution environment of the second cloud component. If the cloud component is authenticated, then the request is fulfilled, as in 406. If the cloud component is not authenticated, then the request is not fulfilled, as in 408.

Turning to FIG. 5, FIG. 5 is an example flowchart illustrating possible operations of a flow 500 that may be associated with securing access to cloud components, in accordance with an embodiment. In an embodiment, one or more operations of flow 500 may be performed by one or more of cloud manager 106, scheduler 108, secure domain 110a, and virtual machines 112a and 112b. At 502, a cloud component is created. At 504, a type is associated with the cloud component. At 506, a verification key that can be used to verify the type of cloud component is created. At 506, the verification key is stored in a trusted domain of the cloud component.

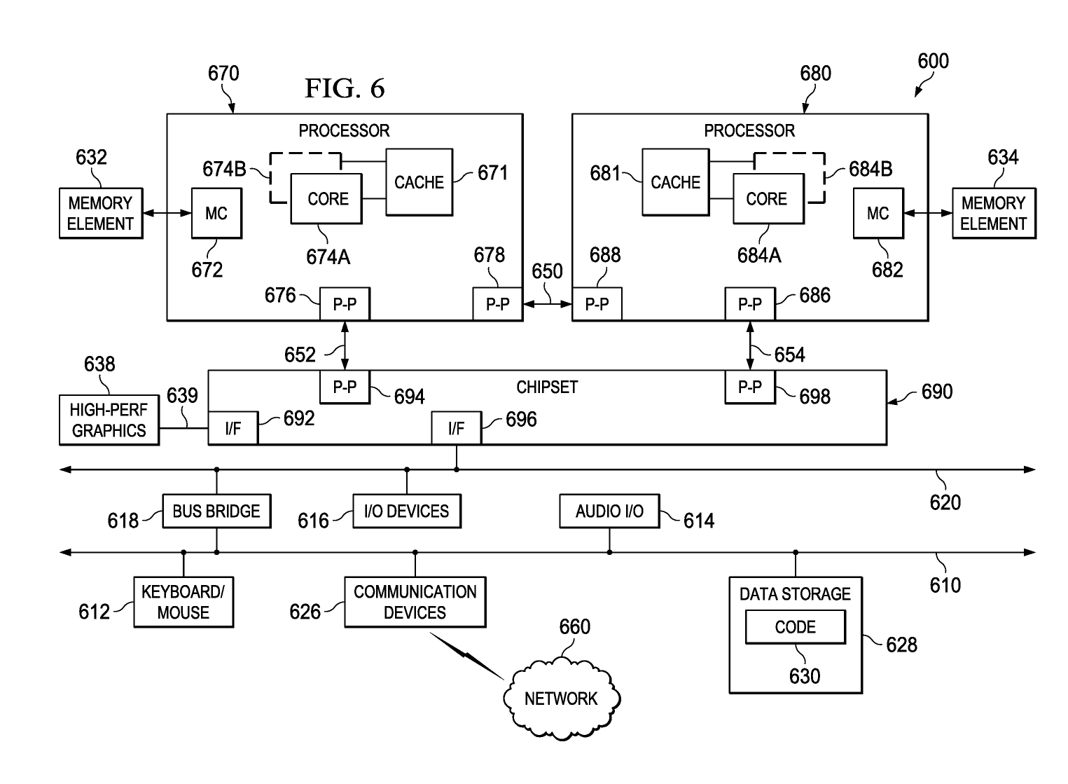

Turning to FIG. 6, FIG. 6 illustrates a computing system 600 that is arranged in a point-to-point (PtP) configuration according to an embodiment. In particular,

FIG. 6 shows a system where processors, memory, and input/output devices are interconnected by a number of point-to-point interfaces. Generally, one or more of the network elements (e.g., cloud manager 106, scheduler 108, virtual machines 112a and 112b, network element that TEE 110a runs on, etc.) of communication system 100 may be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 1-5. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discrete logic separate from processors 670 and 680.

Processors 670 and 680 may be any type of processor and may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

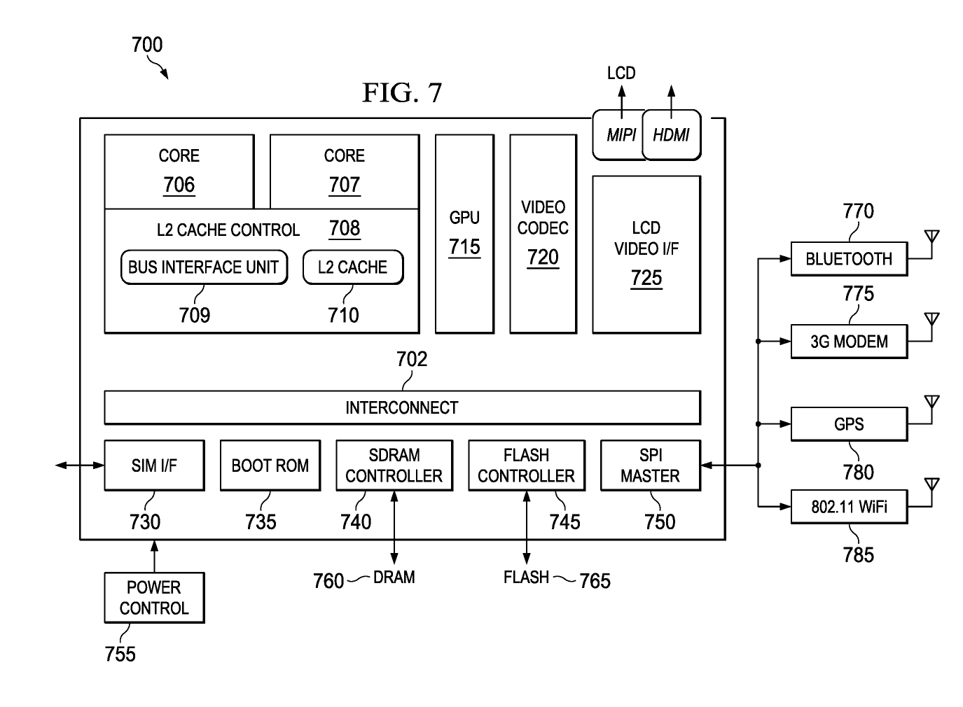

Turning to FIG. 7, FIG. 7 is a simplified block diagram associated with an example ecosystem SOC 700 of the present disclosure. At least one example implementation of the present disclosure can include the device pairing in a local network features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 7, ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

Ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

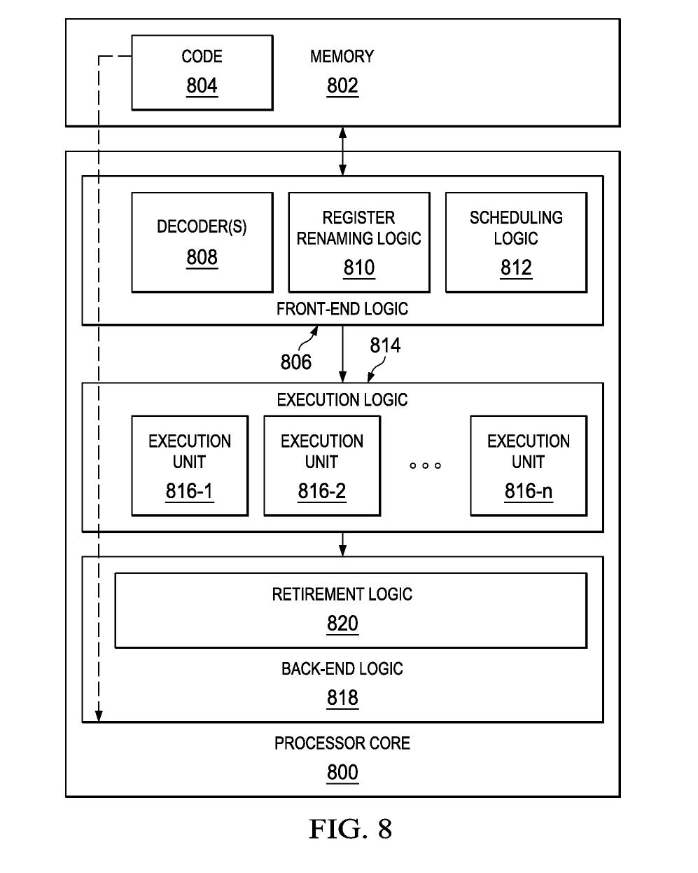

FIG. 8 illustrates a processor core 800 according to an embodiment. Processor core 800 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents one example embodiment of processors cores 874a, 874b, 884a, and 884b shown and described with reference to processors 870 and 880 of FIG. 8. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 6. For example, as shown in FIG. 6, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations in the preceding flow diagrams (i.e., FIGS. 2-5) illustrate only some of the possible correlating scenarios and patterns that may be executed by, or within, communication system 100. Some of these operations may be deleted, combined, or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate securing access to cloud components, these elements and operations may be replaced by any suitable architecture, protocols, and/or processes that achieve the intended functionality of communication system 100.

As used herein, unless expressly stated to the contrary, use of the phrase ‘at least one of’ refers to any combination of the named elements, conditions, or activities. For example, ‘at least one of X, Y, and Z’ is intended to mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular nouns (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements that are not necessarily limited by any order, rank, importance, temporal sequence, or hierarchy of the two elements.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Note that all optional features of the apparatuses and systems described above may also be implemented with respect to the method or process described herein and specifics in the examples may be used anywhere in one or more embodiments.

The following examples pertain to embodiments in accordance with this specification. The subject matter of Example M1 provides for securing access to cloud components. Example M1 provides an apparatus, a system, one or more machine readable storage mediums, a method, and/or hardware-, firmware-, and/or software-based logic to: receive a request from a first cloud component in a cloud network, where the request is to obtain a key and the key allows the first cloud component to access a trusted execution environment of a second cloud component located in the cloud network, and allow the request on the condition that the first cloud component is authenticated.

In Example M2, the subject matter of Example M1 can optionally include to determine a type for the first cloud component, and compare the determined type of the first cloud component with a component type associated with the key.

In Example M3, the subject matter of Example M2 can optionally include to block the request if the determined type of the first cloud component does not match the component type associated with the key.

In Example M4, the subject matter of any one of the Examples M1-M3 can optionally include the first cloud component being authenticated based on an attestation from the first cloud component that indicates software associated with the request from the first cloud component is signed by a valid signing key.

In Example M5, the subject matter of any one of the Examples M1-M4 can optionally include the first cloud component being authenticated based, at least in part, on determining that software associated with the request from the first cloud component is running in another trusted execution environment.

In Example M6, the subject matter of any one of the Examples M1-M5 can optionally include the first cloud component being authenticated based, in part, on determining that the software associated with the request from the first cloud component is identified in an approved software list.

In Example M7, the subject matter of any one of the Examples M1-M6 can optionally include the request to access the second cloud component including accessing data associated with the second cloud component.

In Example M8, the subject matter of any one of the Examples M1-M7 can optionally include the request to access the second cloud component including running a process in the trusted execution environment of the second cloud component.

In Example M9, the subject matter of any one of the Examples M1-M8 can optionally include the request to access the second cloud component including causing the second cloud component to perform one or more operations.

In Example M10, the subject matter of any one of the Examples M1 or M6-M9 can optionally include to receive a verification key from the cloud component, wherein the verification key at least partially determines if the cloud component is authenticated.

In Example M11, the subject matter of any Example M10 can optionally include where the verification key was assigned to the cloud component when the cloud component was created.

In Example M12, the subject matter of any one of the Examples M10-M11 can optionally include to determine a type for the cloud component, and to authenticate the cloud component if the determined type matches the verified type included in the verification key.

Example X1 is an apparatus for securing access to cloud components the apparatus comprising means for performing the method of any one of Examples M1-M12. In Example X2, the subject matter of Example X1 can optionally include the means for performing the method comprising at least one processor and at least one memory element. In Example X3, the subject matter of Example X2 can optionally include the at least one memory element comprising machine readable instructions that when executed, cause the apparatus to perform the method of any one of Examples M1-M12. In Example X4, the subject matter of any one of Examples X1-X3 can optionally include the apparatus being a computing system.

Example Y1 is at least one machine readable storage medium comprising instructions for securing access to cloud components, where the instructions when executed realize an apparatus or implement a method as described in any one of Examples M1-M12.

What is claimed is:

1. At least one machine readable medium comprising one or more instructions that when executed by at least one processor, cause the at least one processor to:
receive a request from a first cloud component in a cloud network, wherein the request is to obtain a key and the key allows the first cloud component to access a trusted execution environment of a second cloud component located in the cloud network; and
allow the request on the condition that the first cloud component is authenticated.

2. The at least one machine readable medium of claim 1, further comprising one or more instructions that when executed by the at least one processor, cause the at least one processor to:
determine a type for the first cloud component; and
compare the determined type of the first cloud component with a component type associated with the key.

3. The at least one machine readable medium of claim 2, further comprising one or more instructions that when executed by the at least one processor, cause the at least one processor to:
block the request if the determined type of the first cloud component does not match the component type associated with the key.

4. The at least one machine readable medium of claim 1, wherein the first cloud component is authenticated based on an attestation from the first cloud component that indicates software associated with the request from the first cloud component is signed by a valid signing key.

5. The at least one machine readable medium of claim 1, wherein the first cloud component is authenticated based, at least in part, on determining that software associated with the request from the first cloud component is running in another trusted execution environment.

6. The at least one machine readable medium of claim 5, wherein the first cloud component is authenticated based, in part, on determining that the software associated with the request from the first cloud component is identified in an approved software list.

7. The at least one machine readable medium of claim 1, wherein the request to access the second cloud component includes accessing data associated with the second cloud component.

8. The at least one machine readable medium of claim 1, wherein the request to access the second cloud component includes running a process in the trusted execution environment of the second cloud component.

9. The at least one machine readable medium of claim 1, wherein the request to access the second cloud component includes causing the second cloud component to perform one or more operations.

10. The at least one machine readable medium of claim 1, further comprising one or more instructions that when executed by the at least one processor, cause the at least one processor to:
receive a verification key from the cloud component, wherein the verification key at least partially determines if the cloud component is authenticated.

11. The at least one machine readable medium of claim 10, wherein the verification key was assigned to the cloud component when the cloud component was created and the verification key includes a verified type for the cloud component.

12. The at least one machine readable medium of claim 11, further comprising one or more instructions that when executed by the at least one processor, cause the at least one processor to:
determine a type for the cloud component; and
authenticate the cloud component if the determined type matches the verified type included in the verification key.

13. An apparatus for securing access to cloud components comprising:
logic, at least partially comprising hardware logic, to:
receive a request from a first cloud component in a cloud network, wherein the request is to obtain a key and the key allows the first cloud component to access a trusted execution environment of a second cloud component located in the cloud network; and
allow the request on the condition that the first cloud component is authenticated.

14. The apparatus of claim 13, wherein the logic is further to:
determine a type for the first cloud component; and
compare the determined type of the first cloud component with a component type associated with the key.

15. The apparatus of claim 14, wherein the logic is further to:
block the request if the determined type of the first cloud component does not match the component type associated with the key.

16. A method for securing access to cloud components comprising:
receiving a request from a first cloud component in a cloud network, wherein the request is to access a key and the key allows the first cloud component to access a trusted execution environment of a second cloud component located in the cloud network; and
allowing the request on the condition that the first cloud component is authenticated.

17. The method of claim 13, further comprising:
determining a type for the first cloud component; and
comparing the determined type of the first cloud component with a component type associated with the key.

18. The method of claim 14, further comprising:
blocking the request if the determined type of the first cloud component does not match the component type associated with the key.

19. A system for securing access to cloud components, the system comprising:
a processor; and
an authentication engine coupled to the processor, wherein the authentication engine comprises logic and is executable by the processor to:
receive a request from a first cloud component in a cloud network, wherein the request is to access a key and the key allows the first cloud component to access a trusted execution environment located in the cloud network; and
allow the request on the condition that the first cloud component is authenticated.

20. The system of claim 19, wherein the authentication engine is further executable by the processor to:
determine a type for the first cloud component; and
compare the determined type of the first cloud component with a component type associated with the key.

21. The system of claim 20, wherein the authentication engine is further executable by the processor to:
block the request if the determined type of the first cloud component does not match the component type associated with the key.

22. The system of claim 19, wherein the first cloud component is authenticated based on an attestation from the first cloud component that indicates software associated with the request from the first cloud component is signed by a valid signing key.

23. The system of claim 19, wherein the first cloud component is authenticated based, at least in part, on determining that software associated with the request from the first cloud component is running in another trusted execution environment.

24. The system of claim 23, wherein the first cloud component is authenticated based, in part, on determining that the software associated with the request from the first cloud component is identified in an approved software list.

25. The system of claim 19, wherein the request to access the second cloud component includes accessing data associated with the second cloud component.
